(19) United States
(12) Patent Application Publication
(10) Pub. No.: US 2008/0197551 A1
(43) Pub. Date: Aug. 21, 2008

(54) Hydraulic Antivibration Support, and Method of Manufacturing Same

(75) Inventors: Bertrand Thibault, Grand Rapids, MI (US); Terry Houston, Grand Rapids, MI (US); Clayton Maas, Grand Rapids, MI (US)

Correspondence Address: MILLER, MATTHIAS & HULL, ONE NORTH FRANKLIN STREET, SUITE 2350, CHICAGO, IL, 60606, US

(73) Assignee: PAULSTRA CRC, Grand Rapids, MI (US)

(21) Appl. No.: 11/676,826

(22) Filed: Feb. 20, 2007

(51) Int. Cl. B23P 13/00; F16F 9/00

(52) U.S. Cl. 267/140.13; 29/896.93

(57) ABSTRACT

A hydraulic antivibration support comprising a first rigid member; a second rigid member; a substantially frusto-conical elastomer body, extending vertically along a central axis between the first and second rigid members, wherein the working chamber and the compensation chamber are partially superposed along said central axis. The elastomer body is adapted to support static loads and defines inwardly a working chamber and partially defines outwardly an annular compensation chamber. The support further includes a flexible annular skirt defining the compensation chamber together with the elastomer body, the flexible skirt being molded as a single piece with the elastomer body, and a rigid covet, sealingly closing at least the working chamber A passage communicates between the working chamber and the compensation chamber, the working chamber, the compensation chamber and the passage being filled with liquid

### FIELD OF THE INVENTION

The present invention relates to hydraulic antivibration supports and to a method of manufacturing the same More particularly the present invention relates to hydraulic antivibration supports comprising:

a first rigid member;

a second rigid member;

a substantially frusto-conical elastomer body, extending vertically along said central axis between said first and second rigid members between a base and a crown, said elastomer body being adapted to support said static loads and defining inwardly a working chamber and partially defining outwardly an annular compensation chamber,

a flexible annular skirt defining said compensation chamber together with said elastomer body, said flexible skirt extending from a first extremity integral to the crown of the elastomer body to a second extremity attached to the first rigid member close to the base of the elastomer body;

a rigid cover, sealingly closing at least said working chamber;

a passage communicating between said working chamber and said compensation chamber, the working chamber; the compensation chamber and the passage being filled with liquid

### BACKGROUND OF THE INVENTION

Such supports are known in the art, for example through document U.S. Pat. No. 5,855,364. Nevertheless, such a support makes inefficient use of the elastomer body, and as a result can be considered quite bulky for a given volume of hydraulic liquid

### SUMMARY OF THE INVENTION

To mitigate this drawback, the working chamber and the compensation chamber may be partially superposed along the central axis and are separated by said elastomer body

By means of this disposition, the antivibration support can be molded in one operation using less elastomer material, thus reducing costs Indeed, the present invention makes more efficient use of the elastomer body to distribute stresses taken up by external loads.

In preferred embodiments, use is also reserved for one or more of the following dispositions:

the working chamber and the compensation chamber are concentric;

the rigid cover further comprises at least one outwardly extending tab, said tab adapted to secure said first rigid member against said rigid covet;

the elastomer body is overmolded over the first and second rigid members;

the second extremity of the flexible skirt is overmolded over a third annular rigid member, said third annular rigid member abutting the first rigid member;

the second extremity of the flexible skirt is overmolded over a third annular rigid member, said third annular rigid member abutting the first rigid member;

the third annular rigid member further acts as a vertical displacement limiter;

a plate is interposed between the rigid cover and the elastomer body, said rigid covet and said plate defining a channel together;

comprising a central well able to receive a fixation element, the rigid cover being annular, the working chamber being annular with an inner peripheral wall bounding said central well;

the central well is a through-hole

These dispositions allow for a mote compact support, able to take up less radial space than conventional supports Indeed, the frusto-conical shape of the elastomer body allows for a partial superposition of the working chamber and the compensation chamber; which in turns decreases the volume and the radial envelope of the support.

The present invention also provides for a method of fabricating such supports. More particularly, the method off fabrication involves:

molding in one piece the elastomer body and the flexible annular skirt, said flexible skirt projecting out from the crown, away from the base;

folding back in an upwardly direction said flexible skirt thus defining the compensation chamber;

attaching said flexible skirt to the first rigid member, and attaching the rigid cover to said elastomer body, thereby sealing and defining the working chamber and allowing fluidic communication between said working chamber and said compensation chamber.

### BRIEF DESCRIPTION OF THE DRAWINGS

Other characteristics and advantages of the invention will appeal from the following detailed description of an embodiment thereof, given by way of non-limiting example and with reference to the accompanying drawings, in which:

FIG. 1 is a side sectional view of the hydraulic antivibration support according to an embodiment of the invention, after assembly;

FIG. 2 is a view of the rigid plate;

FIG. 3 is a view of the underside of the rigid cover; and

FIG. 4 is a side sectional elevation view of the elastomer body before assembly.

### DETAILED DESCRIPTION

In the following description, terms such as “up”, “down”, “top”, and “bottom”, are given purely by way of illustration and in reference to the most common position in which the hydraulic antivibration support is used, however these terms are in no way limitative.

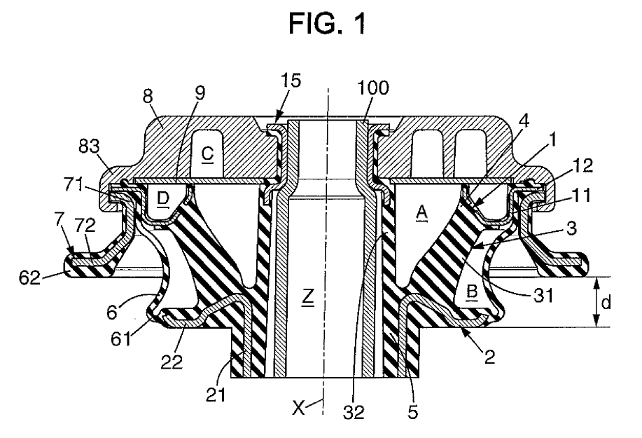

The hydraulic antivibration support as shown in FIG. 1 is designed to be interposed between a first and a second rigid element. Such rigid elements may consist of a motor vehicle body and a vehicle frame. This hydraulic antivibration support is adapted for supporting the aforementioned first and second rigid elements, and for filtering dynamic loads between them. The static loads normally consist of the permanent engine and/or vehicle body weight, while the dynamic loads usually consist of engine vibration, other induced loads due to vehicle travel on uneven roads, ox similar.

The hydraulic antivibration support according to this embodiment comprises first and second rigid members 1, 2 for contacting and securing these said external rigid elements Disposed between the first rigid member 1 and the second rigid member 2 is an elastomer body 3 having a hollow, substantially frusto-conical shape (e.g. bell shaped), or similar, extending along a central vertical axis X, between an annular base 4 on the top side and a crown 5 on the bottom side.

The first rigid element 1, overmolded and adhered to the elastomer body 3, consists of an annular channel 11 with a substantially U-shaped cross-section, the external wall thereof extending outwardly into a substantially flat horizontal lip 12. The lip 12 is disposed for supporting and transferring loads from the external element.

The second rigid member 2 is overmolded and adhered in the crown 5 of the elastomer body 3, and consists of a vertically extending tubular wall 21, continuing into a horizontally extending section 22 The rigid member 2 is predisposed to abut and contact directly against a second rigid element.

The first rigid member 1, the elastomer body 3, and the second rigid member 2 are disposed along a substantially vertical central axis X.

An annular working chamber A is partially defined by an angularly orientated load-bearing wall 31, the load-bearing wall 31 constituting part of the elastomer body 3 The working chamber A is further partially defined by an elastomeric tubular wall 32 extending upwardly from the crown 5, coaxially with the central axis X The elastomeric tubular wall 32 also lines the interior surface of the tubular wall 21 of the second rigid member 2.

For fixation purposes, the hydraulic antivibration device as illustrated comprises a hollowed out cylindrical central volume Z defined by the interior wall of the tubular wall 32. This volume Z may be lined with a tubular sleeve 100 to protect the elastomeric tubular wall 32 from damage. The cylindrical volume Z is habitually used for passing fixation means, for example a bolt, from the bottom side of the support to the top, so as to fix the two external elements together.

The hydraulic antivibration device further comprises an annular skirt 6 extending outwardly from a first extremity 61 integrally molded out from the crown portion 5 of the elastomer body 3 adjacent to the extremity of the horizontal section 22 of the second rigid member 2, towards a free end portion 62 located by the first rigid member. A third rigid member 7 is over-molded and adhered inside the end portion 62 of the annular skirt 6. The third rigid member 7 comprises a top section 71 formed to mate and abut with first rigid element 1, and more specifically to abut with both the exterior wall of the U-shaped channel 11 and the horizontal lip 12 By this disposition, the annular skirt 6 is interposed between the third rigid member 7 and the first rigid member 1, close to the base of the elastomer body, providing a sealed binding of the annular skirt 6 to the first rigid member 2.

The third rigid member 7 further comprises a horizontal base 72 protruding exteriorly from the support, serving as a vertical displacement limitation over a predetermined distance d corresponding to the distance between the horizontal base 72 and the horizontally extending section 22 of the second rigid member 2.

The third rigid member therefore provides for a way of conveniently fixing the flexible annular skirt, as well as to limit over-compression of the antivibration support by forcibly preventing any further compression than what is predetermined by the spacing of between the base of the third rigid member and the supporting base 22 of the second rigid member.

Once bound to the first rigid member 2, the annular skirt 6, together with the angular load bearing wall 31, sealingly define together an annular compensation chamber B on the exterior portion of the support. This way, the hydraulic antivibration support comprises and defines essentially two concentric chambers, namely the inner working chamber A and the outer compensation chamber B.

A fourth rigid annular member 15 is disposed by overmolding and adhesion in the upper portion of the upwardly extending tubular wall 32 to rigidify the said wall 32 and help maintain its shape and position.

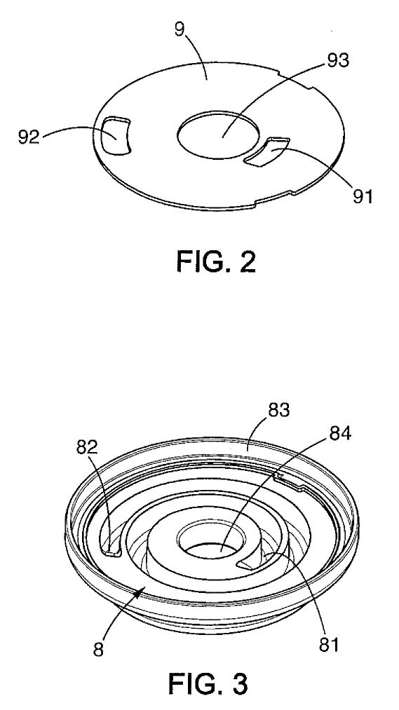

The hydraulic antivibration support further comprises a plate 9 and a rigid cover 8, illustrated individually in FIGS. 2 and 3.

The rigid cover 8 is positioned above the elastomer body 3, and is supported by the plate 9 and by the first rigid member 1

The rigid cover 8 is circular and defines a central hole 84 to receive the fourth rigid member 15. It further comprises an outwardly extending tab adapted to secure by crimping the first rigid member 1 against itself

The rigid cover 8 further comprises a constricted passage in the form of a channel C, allowing fluidic communication between the working chamber A and the compensation chamber B The channel C spirals from an inner first extremity 81 to an outer second extremity 82.

The length and cross-section of the channel C are specifically sized such that, upon fluid transfer between the working chamber A and the compensation chamber B, for example as a result of external dynamic inputs, it generates inertial damping at a specific frequency which is a function of its dimensions.

The plate 9 is disc-shaped and sealingly interposed between the rigid cover 8, and the elastomer body 3 and the first rigid member 1. Furthermore, the plate 9 also partially delimits the working chamber A, thus forming a closed volume working chamber A together with the upwardly extending tubular wall 32 and the angular load beating wall 31.

The plate 9 further comprises a first and a second through hole 91, 92, and a central hole 93 The first through hole 91 is aligned with both the working chamber A and with the first extremity 81 of the channel C on the cover 8. The second through hole 92 is aligned with both the compensation chamber B and with the second extremity 82 of the channel C on the cover 8. The central hole 93 has substantially the same size, shape, and position as the central hole 84 of the cover 8.

The working chamber A and the compensation chamber B each have respective openings to communicate with channel C. The working chamber A, the compensation chamber B, and the channel C thus constitute a single sealed volume, and whereby this volume is filled with liquid.

In particular, the second extremity 82 and the second hole 92 of the cover 8 and of the plate 9 respectively, communicate into a volume D defined by the interior walls of the first rigid member 1. The rigid member 1 further has a cut-out (non-represented) in the bottom section thereof to communicate with the compensation chamber B.

The tab 83 further clamps the third rigid member 7 sealingly against the first rigid member 1 and the plate 9, thus also sealingly clamping the annular skirt 6 between the respective rigid members

The above-mentioned fourth rigid member 14 serves to further secure the cover 8 in place by crimping its extremity over the cover 8

The geometry of the elastomer body 3 is such that the working chamber A and the compensation chamber B that it defines are partially superposed along the central axis X direction, and are separated from each other by the elastomer body 3

This way, the angularly extending load-bearing wall 31 is adapted to efficiently support the static and dynamic loads between the first rigid member 1 and the second rigid member 2 without using unnecessary elastomer material

The load-bearing wall 32, as well as supporting the loads, is well adapted for displacing fluid inside the channel C under external dynamic inputs During operation of the presently presented embodiment, vertically acting input loads applied between the first rigid element 1 and the second rigid element 2 will, because of its geometry, deform the load-beating wall 31 by compression towards a more horizontal position. This, of course, reduces the working volume of the working chamber A such as to solicit the contained fluid outwards into the channel C, and further into the compensation chamber B. Due to the flexibility of its exteriorly positioned annular skirt 6, the compensation chamber B will distend from the increased internal pressure due to the accumulation of the transferred fluid from the working chamber A via the channel C.

As explained hereabove, the channel C is specifically dimensioned to inertially damp a specific frequency, such that under external dynamic excitations corresponding to a particularly incommodious frequency, such as natural engine vibration or typical road-induced excitation at a particular speed, such inputs will be damped, ameliorating the comfort of the user

The presently presented embodiment offers advantages over the existing art.

In a first advantage, due to its disposition of having the elastomer body 3 and the annular skirt 6 broadly defining a rectangular cross sectional shape, and having this rectangular cross section diagonally traversed by the principal load-bearing wall 31 such that both the working chamber A and the compensation chamber B form roughly triangular cross sectional shapes, a greater volumetric efficiency is achieved.

In a further advantage, the present invention allows the entire elastomeric parts of the support to be molded in one piece, thus saving time and money.

Of course, it will be understood that the present invention is not restricted to the presently presented embodiment

An alternative embodiment may, for example, be of a solid construction and not comprise the central hollow cylindrical portion Z. The working chamber A would therefore be a hollow rhombus shape There would also be no need for an elastomeric tubular wall 32, and therefore no need for a fourth rigid member 15 to stiffen the tubular wall 32 The second rigid member 2 would therefore normally be in the shape of a solid base encased in the crown portion 5 of the elastomer body 3, and be disposed with a stud for fixing to an exteriorly disposed rigid element.

The present invention also regards a method of assembling a hydraulic antivibration support as presented above.

The method comprises a first step of molding in one piece the elastomer body 3 and the flexible annular skirt 6.

Next, the method comprises folding back in an upwardly direction the flexible skirt 6, thus defining the compensation chamber B

Lastly, the method comprises attaching the flexible skirt 6 to the first rigid member 1, and attaching the rigid cover 8,9 to the elastomer body 3, thereby sealing and defining the working chamber A and allowing fluidic communication between the working chamber A and the compensation chamber B.

The assembling steps may further comprise an intermediate step of overmolding, encasing, or adhering the third annular rigid member 7 at the free end portion 62 of the flexible skirt 6. In the step of folding back upwardly the flexible annular skirt 6, the third annular rigid member 7 would come to abut and seat itself by the first rigid member 1.

In the case that the third annular rigid member 7 is destined to also act as a vertical displacement limiter (or a compression stop), the third annular rigid member 7 if formed to provide an horizontal base 72 as described hereabove, and abuts the first rigid member 1 in a way that permits is to limit the compression of the support by external forces by forcibly limiting its vertical movement.

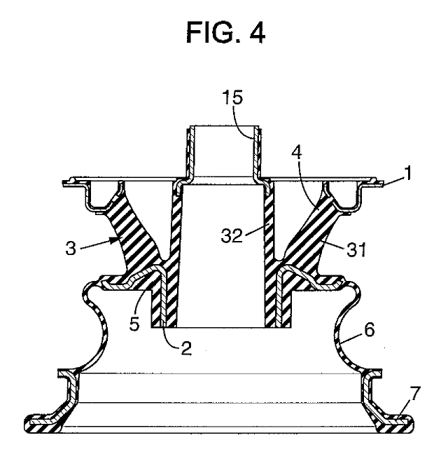

The one-piece molding may be obtained in the steps of the above-mentioned method is illustrated in FIG. 4.

The one-piece molding comprises the elastomer body 3, the tubular wall 31 and the flexible annular skirt 6, the flexible annular skirt 6 normally protecting outwardly from the crown portion 5, and away from the base 4. The first, second, third and fourth rigid member 1, 2, 7, 15 are over molded by the elastomeric material, for example through a process of bi-injection

Subsequently, during assembly, the skirt 6 of the molded piece is folded back in an upwardly direction, towards the first rigid member 1. As a result, the overmolded third rigid member 7 comes into abutment and effectively seals the annular skirt 6 onto the walls of the first rigid member 1, thus providing effective sealing for the compensation chamber B, and a displacement limiter over distance d.

Next, plate 9 is assembled, aligning the first hole 91 with the working chamber A, and the second hole 92 with the compensation chamber B. The rigid cover may be disposed on top of the plate, having the first extremity of the passage C mating up and aligning with the first hole of the base plate and the working chamber, and a second extremity of the passage C mating up and aligning with second hole 92 and the compensation chamber B. The annular tab 83 of the rigid cover 8 is then crimped around the third rigid member 7, thus securing and sealing the annular skirt in between the first rigid member 1 and the third member 7 and binding everything together. The upper portion fourth rigid member 15 is also crimped over the central hole 84 of the cover 8.

Lastly, the interior volume of the working chamber A, the channel C and the compensation chamber B is filled with fluid by any means know to persons of the art, such as by a vacuum-injection process or by performing the assembly steps with the part immersed in fluid.

Alternatively, the channel C may be disposed as part of a thicker plate 9, such that the rigid cover 8 would simply serve as a sort of cover plate

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed, but that the invention will include all embodiments falling within the scope of the appended claims

We claim:

1. A hydraulic antivibration support for interposing between a first and second rigid element, and adapted for supporting and filtering static and dynamic loads between said first and second rigid elements along a central axis, said support comprising:
a first rigid member;
a second rigid member;
a substantially frusto-conical elastomer body, extending along said central axis between said first and second rigid members between a base and a crown, said elastomer body being adapted to support said static loads and defining inwardly a working chamber and partially defining outwardly an annular compensation chamber,
a flexible annular skirt defining said compensation chamber together with said elastomer body, said flexible skirt extending from a first extremity integral to the crown of the elastomer body to a second extremity attached to the first rigid member close to the base of the elastomer body;
a rigid cover, sealingly closing at least said working chamber;
a passage communicating between said working chamber and said compensation chamber, the working chamber, the compensation chamber and the passage being filled with liquid;
wherein said working chamber and said compensation chamber are partially superposed along said central axis and are separated by said elastomer body.

2. A support according to claim 1, wherein the working chamber and the compensation chamber aye concentric.

3. A support according to claim 1, wherein the rigid cover further comprises at least one outwardly extending tab, said tab adapted to secure said first rigid member against said rigid cover.

4. A support according to claim 1, wherein the elastomer body is overmolded over the first and second rigid members.

5. A support according to claim 1, wherein the second extremity of the flexible skirt is overmolded over a third annular rigid member, said third annular rigid member abutting the first rigid member.

6. A support according to claim 5, wherein the third annular rigid member further acts as a vertical displacement limiter.

7. A support according to claim 1, wherein a plate is interposed between the rigid cover and the elastomer body, said rigid cover and said plate defining a channel together.

8. A support according to claim 1, further comprising a central well able to receive a fixation element, the rigid cover being annular, and the working chamber being annular with an inner peripheral wall bounding said central well.

9. A support according to claim 8, wherein the central well is a through-hole.

10. A method of assembling a hydraulic antivibration support according to claim 1, said method comprising:
molding in one piece the elastomer body and the flexible annular skirt, said flexible skirt projecting out from the crown, away from the base;
folding back in an upwardly direction said flexible skirt, thus defining the compensation chamber;
attaching said flexible skirt to the first rigid member, and attaching the rigid cover to said elastomer body, thereby sealing and defining the working chamber and allowing fluidic communication between said working chamber and said compensation chamber

11. A method according to claim 10, further comprising overmolding a third annular rigid member to the flexible skirt, said third annular rigid member being destined to abut the first rigid member after folding said annular skirt.

12. A method according to claim 11, wherein the third annular rigid member is formed to act as a vertical displacement limiter

13. A hydraulic antivibration support for interposing between a first and second rigid element, and adapted for supporting and filtering static and dynamic loads between said first and second rigid elements along a central axis, said support comprising:
a first rigid member;
a second rigid member;
a substantially frusto-conical elastomer body comprising a through-hole able to receive a fixation element, said elastomer body being overmolded over said first and second rigid members, extending vertically along said central axis between said first and second rigid members between a base and a crown, said elastomer body being adapted to support said static loads and defining inwardly a working chamber and partially defining outwardly an annular compensation chamber; said working chamber and said compensation chamber being annular, concentric and partially superposed along said central axis and being separated by said elastomer body, and said working chamber having an inner peripheral wall bounding said through-hole;
a flexible annular skirt defining said compensation chamber together with said elastomer body, said flexible skirt being molded as a single piece with said elastomer body, and extending from a first extremity integral to the crown of the elastomer body to a second extremity attached to the first rigid member close to the base of the elastomer body, said second extremity of the flexible skirt being further overmolded over a third annular rigid member, and said third annular rigid member abutting the first rigid member and acting as a vertical displacement limiter;
an annular rigid cover, sealingly closing at least said working chamber, and further comprising at least one outwardly extending tab, said tab adapted to secure said first rigid member against said rigid cover; and
a passage communicating between said working chamber and said compensation chamber, the working chamber, the compensation chamber and the passage being filled with liquid
